(19) United States
(12) Patent Application Publication
(10) Pub. No.: US 2008/0190776 A1
(43) Pub. Date: Aug. 14, 2008

(54) Heat spreader plating methods and devices

(76) Inventors: Paul Silinger, Spokane, WA (US); Brent S. Bowler, Newman Lake, WA (US); Brian P. Knight, Post Falls, ID (US); Ross Schlotthauer, Post Falls, ID (US)

Correspondence Address: BUCHALTER NEMER, 18400 VON KARMAN AVE., SUITE 800, IRVINE, CA, 92612, US

(21) Appl. No.: 11/705,933

(22) Filed: Feb. 13, 2007

(51) Int. Cl. B23H 11/00

(52) U.S. Cl. 205/137; 204/193; 204/297.14

(57) ABSTRACT

Clip devices contemplated herein comprise a metal-containing base, wherein the base comprises a lower clip body and an upper clip body, and wherein the lower clip body further comprises at least two sets of electrically conducting wire springs. Contemplated electrically conducting wire springs comprise at least one non-contact body section and a plurality of contact points. Methods of plating parts or workpieces include: a) submerging a work piece to be plated in a volume of plating solution; b) positioning a work piece to be plated at least partially within an upper plating channel and a lower plating channel, the upper and lower plating channels comprising non electrically conductive sides, the channels being positioned opposite each other and being separated from each other, the separation between the channels forming a pair of solution egress slots positioned approximately over the center of the work piece to be plated; c) causing electrical current to flow between the work piece and one or more anodes, the current flowing into the upper and lower channels only after passing through the solution egress slots; and d) moving the work piece to be plated along the length of the plating channels to form one or more internal heat spreaders on a surface of the work piece which is essentially parallel to the shields. Plating systems comprising disclosed clip devices are also contemplated.

This application claims priority to our co-pending International Application filed with the United States Receiving Office on Feb. 5, 2007 (serial number to be provided at a later date), and entitled “HEAT SPREADER PLATING METHODS AND DEVICES.”

### FIELD OF THE INVENTION

The field of the invention is methods of plating heat spreaders and other parts designed for thermal management of semiconductor devices.

### BACKGROUND OF THE INVENTION

A common continuous plating system comprises an elongated plating chamber/cell and a movement mechanism designed to move parts along the length of the cell while the parts are being plated. The chamber is sufficiently long so that the plating of a part which enters the chamber at one end and exits at the other can be completed by the time the part traverses the length of the chamber.

Referring to Prior Art FIG. 1, previously known plating systems such as the MP 300 available from Technic Inc. utilize vertical solution spargers 11 to introduce plating solution 80 into the plating compartment 12 and to direct the incoming solution 80 towards the parts 90 being plated. Known systems also use electrically insulating shields 13 to manipulate the flow of current between the cathode/part 90 and one or more anode baskets 14. As shown in Prior Art FIG. 1, the distance D1 between the shields 13 and the part being plated 90 is sufficiently great so as to allow the part 90 to be moved between vertical spargers 11 which are placed between the part 90 and the shields 13. Systems similar to those of Prior Art FIG. 1 are typically used to plate a single edge 91 of a printed circuit board 90 with the edge being plated 91 being submerged in the plating solution 80 and the opposite edge 92 being positioned out of the plating solution 80. Systems similar to those of FIG. 1 typically comprise an inner cell 15 used for plating, an outer cell 16 for solution return, one or more fluid inlets 15A and one or more fluid outlets 16A. Fluid typically enters inner cell 15 via fluid inlet 15A, flows out of inner cell 15 and into outer cell 16, and then flows out of out cell 16 via fluid outlet 16A.

The items that are sent through the plating system are held in place with a clip arrangement. Obviously, the clips must contact and hold the target items in order to move them through the plating system. In conventional systems, these clips create multiple functional and visual defects for the plated items/parts, including a) burrs caused from the items/parts moving during plating and b) extensive clip marks because of the large clip-holding area. In addition, conventional clip designs having loading mechanisms are reducing the plating production yields and line uptime for at least the following reasons: a) loader frequent malfunctions, b) part scratching because of the heavy part stack load, c) frequent line crashes because of item/part swiveling out of it's vertical position, d) a high rate of dropped parts, contaminating plating baths, further leading to part visual and functional problems, e) limiting useful part size because of clip opening mechanism and bulk design, f) limiting line capacity because of one part per clip maximum capacity and g) extensive downtime and high replacement cost for damaged clip change.

An example of a conventional clip assembly is shown in U.S. Pat. No. 4,401,522 issued on Aug. 30, 1983. In this patent, workpieces are suspended by a non-conductive hanger, which is later rendered conductive (see hanger 34 and clip 35 in FIG. 3 of the reference). It is important to note that the clip is firmly grasping the top portion of the workpiece. This clip assembly cannot carry multiple workpieces at one time and has a relatively large contact area with the workpiece.

U.S. Pat. Nos. 4,668,364 5,346,602, and 5,391,279 describe the use of an alligator clip to hold the parts or workpieces in place during plating. Obviously, these clips have the same problems as those discussed earlier in that they can't hold multiple parts or workpieces and they don't have minimal contact with the parts or workpieces.

U.S. Pat. No. 4,678,545 describes the use of a bracket and screw assembly to hold the parts and workpieces. While this particular arrangement might be able to hold multiple pieces during plating, it has the distinct disadvantage of having a larger than ideal contact area with those parts and workpieces. It is also not clear from the reference whether a multiple part workpiece arrangement would result in parts and workpieces that are fully plated.

Other similar conventional clip assemblies are found in U.S. Pat. Nos. 4,466,864, 5,421,987, 5,558,757, 6,197,182, 6,274,024, 6,274,023, 6,267,862, 6,277,260, 6,827,443, 6,296,753, 6,299,751, 6,361,669, 6,419,805, 6,936,145, 4,539,090, 4,904,363, 5,827,410, 5,772,765, 5,755,935, 6,342,146, and US Publications 2006-0102469, 2006-0103244 and 2006-0103261. These conventional clip assemblies unfortunately suffer from the same disadvantages as those clip assemblies described earlier.

Therefore, it would be ideal to develop a clip device and mechanism that a) does not need to close and open to accept and release parts or workpieces, b) has a much smaller contact area with the part/workpiece, c) does not use an automated loader for parts and workpieces, d) allows for varying part and/or workpiece sizes, e) allows for multiple parts and/or workpieces contained by one clip device and mechanism, and f) provides a quick and low cost clip replacement for damaged clips.

### SUMMARY OF THE INVENTION

Clip devices contemplated herein comprise a metal-containing base, wherein the base comprises a lower clip body and an upper clip body, and wherein the lower clip body further comprises at least two sets of electrically conducting wire springs. Contemplated electrically conducting wire springs comprise at least one non-contact body section and a plurality of contact points.

Methods of plating parts or workpieces include: a) submerging a work piece to be plated in a volume of plating solution; b) positioning a work piece to be plated at least partially within an upper plating channel and a lower plating channel, the upper and lower plating channels comprising non electrically conductive sides, the channels being positioned opposite each other and being separated from each other, the separation between the channels forming a pair of solution egress slots positioned approximately over the center of the work piece to be plated; c) causing electrical current to flow between the work piece and one or more anodes, the current flowing into the upper and lower channels only after passing through the solution egress slots; and d) moving the work piece to be plated along the length of the plating channels to form one or more internal heat spreaders on a surface of the work piece which is essentially parallel to the shields.

Plating systems comprising disclosed clip devices are also contemplated.

### BRIEF DESCRIPTION OF THE DRAWINGS

Prior Art FIG. 1 is a perspective view of a prior art plating system.

Prior Art FIG. 2 is a perspective view of a prior art plating system.

Prior Art FIG. 2A is a detailed view of a part being plated in the system of FIG. 2.

Prior Art FIG. 3A is a top view of a prior art clip suitable for use in the system of FIG. 1.

Prior Art FIG. 3B is a top view of a prior art clip suitable for use in the system of FIG. 2.

Prior Art FIG. 4 is a perspective view of a prior art clip.

FIG. 5 is a perspective view of a contemplated clip device.

### DETAILED DESCRIPTION

Surprisingly, a clip device and mechanism has been developed that a) does not need to close and open to accept and release parts or workpieces, b) has a much smaller contact area with the part/workpiece, c) does not use an automated loader for parts and workpieces, d) allows for varying part and/or workpiece sizes, e) allows for multiple parts and/or workpieces contained by one clip device and mechanism, and f) provides a quick and low cost clip replacement for damaged clips.

It is instructive to review each of these benefits related to the new clip device and mechanism to see why each of these benefits is so important to the working of the plating mechanism. A clip device and mechanism that does not need to close and open greatly minimizes, if not eliminates, burrs, drop parts (and related plating bath contamination) and line crashes. Clip devices and mechanisms that have smaller contact areas can dramatically reduce the clip mark defects on the part/item. Clip devices that do not use automatic loaders can result in parts having reduced scratching and in addition, line downtime due to loader malfunctions are completely eliminated. The last three advantages, along with the other benefits previously mentioned, obtained by the new clip device and mechanism result in increased production, fewer defects and less line downtime.

Clip devices contemplated herein comprise a metal-containing base, wherein the base comprises a lower clip body and an upper clip body, and wherein the lower clip body further comprises at least two sets of electrically conducting wire springs. Contemplated electrically conducting wire springs comprise at least one non-contact body section and a plurality of contact points. Plating systems comprising disclosed clip devices are also contemplated.

As mentioned, clip devices and mechanisms contemplated herein comprise a metal-containing base. It is contemplated that those clip devices, including the lower clip body, the upper clip body and/or the electrically conducting wire springs contemplated comprise metals, metal alloys or other metal-containing materials that are resistant to corrosion and reaction with the solution baths. In some contemplated embodiments, the metal-containing base is fully resistant to corrosion and reaction with solution baths. In other contemplated embodiments, the metal-containing base, the wire springs, and other related parts comprise any suitable conductive material, including pure metals, alloys, conductive polymers and composites. As used herein, the term “metal” means those conductive elements that are in the d-block and f-block of the Periodic Chart of the Elements, such as the transition metals, along with those elements that have metal-like properties, such as silicon and germanium. As used herein, the phrase “d-block” means those elements that have electrons occupying the 3d, 4d, 5d, and 6d orbitals surrounding the nucleus of the element. As used herein, the phrase “f-block” means those elements that have electrons occupying the 4f and 5f orbitals surrounding the nucleus of the element, including the lanthanides and the actinides. Contemplated metals include titanium, silicon, copper, nickel, iron, zinc, zirconium, aluminum and aluminum-based materials, tantalum, tin, chromium, platinum, palladium, gold, silver, tungsten, or a combination thereof. Alloys and metal-containing compositions, such as stainless steel, are also contemplated.

Contemplated metal-containing bases are split into two discrete sections—a lower clip body and an upper clip body. When the base is split into two sections, it is easy, quick and cost effective to change out one of those sections. In addition, each discrete section can be tailored to achieve specific benefits for the overall clip device.

The lower clip body is one of the integral facets of the present disclosure. The lower clip body comprises at least two sets of electrically conducting wire springs attached to the body of the clip, which hold the part, parts and/or workpieces to be plated. These wire springs are designed to provide adequate electrical conductivity and strength to the base when holding the parts and/or workpieces, while minimizing marks to the plated part and/or workpiece either mechanically and/or electro-chemically during etching and/or plating. The wire spring design is optimized for easy part loading and unloading with an intent to protect the plated part and/or workpiece against scratches, dents and burrs. In addition, the wire spring arrangement is specifically designed to hold either single or multiple parts on the same plating fixture, while at the same time is designed to hold different size parts and/or workpieces. Surprisingly, these new clip devices can hold at least one part, wafer, workpiece or combination thereof.

Contemplated electrically conducting wire springs comprise at least one non-contact body section and a plurality of contact points. The non-contact body section is as it sounds—that part of the conducting wire springs which does not contact the part or the current source. The plurality of contact points are those points of the wire springs that touch either the part or the current source.

The lower clip body, including the wire springs, is selectively coated with a non-conductive material, such as a plastic material, to provide protection and to localize metal deposition only on the part or parts to be plated and the plurality of contact points on the conducting wire springs. Contemplated non-conductive materials comprise polypropylene, polyethylene, teflon, halar, PVC, CPVC and combinations thereof.

As mentioned, plating systems comprising disclosed clip devices are also contemplated. These plating systems are any suitable continuous plating systems, wherein one or more parts is currently held by a clip through the process. This new clip design and mechanism can be utilized in conventional and unconventional plating systems and lines, including those systems described in the background section and unconventional systems, such as those systems found in PCT Application Serial No.: PCT/US02/05536 and U.S. application Ser. No. 10/765782, which are both commonly owned by Honeywell International Inc. and both incorporated herein in their entirety by reference. These applications, for example, disclose a plating system 100, which is shown in Prior Art FIG. 2 that provides for improved metal distribution over a work piece 900. In the improved system 100, the vertical spargers (spargers 11 in Prior Art FIG. 1) found in other prior art plating systems are eliminated and fluid 800 enters the chamber 120 through the bottom of the chamber with the bottom of the chamber acting as a horizontal sparger 110. It is contemplated that the use of one or more horizontal spargers 110 having holes/inlets 111 and being located at an end of a chamber 120 at least partially formed by an upper channel 122 and lower channel 121 to direct fluid flow through a first of the channels and towards a second channel so that it flows toward a part 900 positioned relative to a gap 131 between the channels as shown in Prior Art FIGS. 2 and 2A will provide for more turbulent fluid flow and a corresponding higher deposition rate. In order to obtain the desired turbulence, it is preferred that the distance D5 between the upper and lower channels (the width of gaps 131) be as low as 20 percent of the height D6 of work piece 900.

In essence, the shields 130 of Prior Art FIG. 2 form narrow upper and lower plating channels (121 and 122) through which the parts being plated move with each part 900 having one edge 902 positioned within the upper plating channel 122 and an opposite edge 901 positioned within the lower plating channel 121. Because the shields 130 are electrically insulating, current flow between the work piece 900 and the anode baskets 140 is forced to pass through the gaps 131 between the upper and lower shields. Positioning and movement of a part 900 within channel 120 is accomplished by clipping part 900 to a clip 170 and moving clip 170. Prior Art FIG. 3A shows the original design of the part holding clamps/clips 170A utilized by the system of Prior Art FIG. 1 and Prior Art FIG. 3B shows another clip 170 for use in the system of Prior Art FIG. 2. In this embodiment, clip 170 and moving clip 170 may be replaced with the novel clip device disclosed herein.

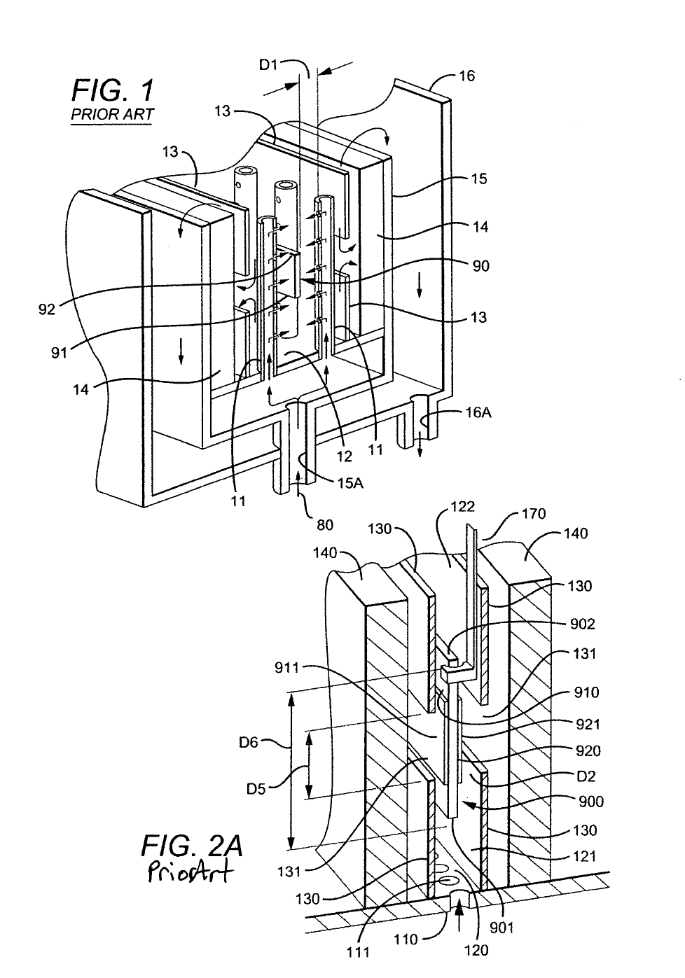

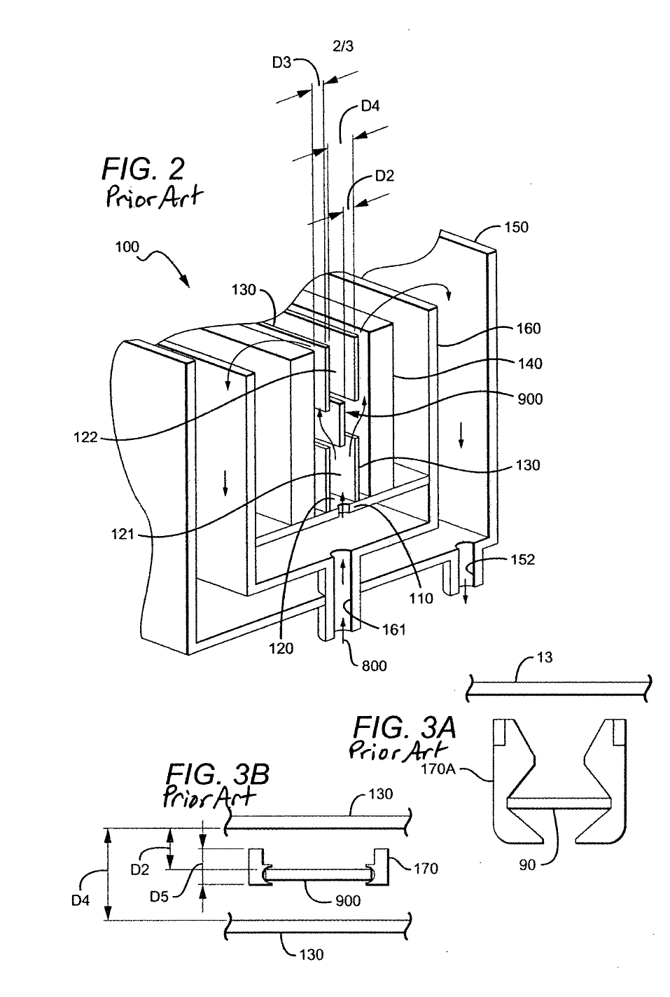

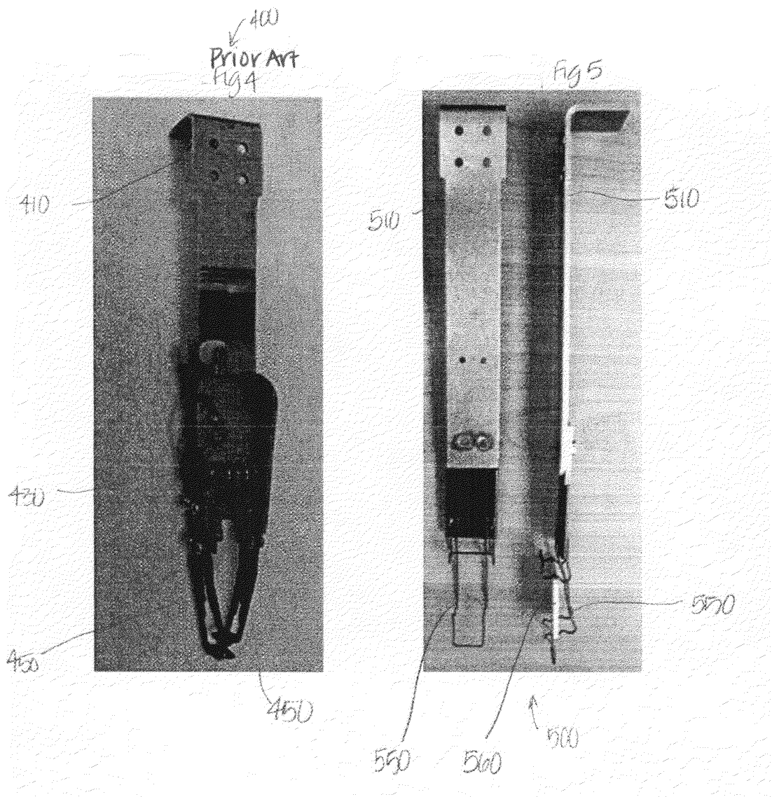

Prior Art FIG. 4 shows the closest conventional clip device 400 to the present clip 500 described herein (shown in FIG. 5). In Prior Art FIG. 4 and FIG. 5, the top attachment assembly 410 and 510, respectively, is substantially the same. Prior Art FIG. 4 shows the conventional arrangement of a tension spring 430 which operates to close the part holder 450. These conventional sections are replaced by one wire spring assembly 550 shown in FIG. 5. The workpiece and/or part 560 is also shown in FIG. 5, and from this figure, it should be obvious that the wire spring assembly 550 can successfully hold more than one part and/or workpiece.

Thus, specific embodiments and applications of an improved plating system have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A clip device, comprising:
a metal-containing base, wherein the base comprises a lower clip body and an upper clip body, and
wherein the lower clip body further comprises at least two sets of electrically conducting wire springs.

2. The clip device of claim 1, wherein the conducting wire springs comprise at least one non-contact body section and a plurality of contact points.

3. The clip device of claim 1, wherein the clip device can hold at least one part, wafer or workpiece.

4. The clip device of claim 3, wherein the clip device can hold a plurality of parts, wafers or workpieces.

5. The clip device of claim 1, wherein the metal-containing base comprises at least one metal.

6. The clip device of claim 5, wherein the at least one metal comprises a transition metal.

7. The clip device of claim 6, wherein the transition metal comprises iron, tantalum, titanium, copper, nickel, aluminum, chromium or a combination thereof.

8. The clip device of claim 7, wherein the metal-containing base comprises stainless steel.

9. The clip device of claim 1, wherein the conducting wire springs comprise at least one metal.

10. The clip device of claim 9, wherein the at least one metal comprises a transition metal.

11. The clip device of claim 10, wherein the transition metal comprises iron, tantalum, titanium, copper, nickel, aluminum, chromium or a combination thereof.

12. The clip device of claim 11, wherein the conducting wire springs comprises stainless steel.

13. The clip device of claim 1, wherein the conducting wire springs are coated at least in part with a non-conductive material.

14. The clip device of claim 9, wherein the non-conductive material comprises polypropylene, polyethylene, TEFLON®, halar, PVC, CPVC or a combination thereof.

15. A plating system comprising:
an upper channel and a lower channel;
a plating solution sparger comprising a series of inlets oriented to direct any plating solution flowing through the inlets into one and towards another of the upper and lower channels; and the clip device of claim 1.

16. A method of plating a work piece, comprising:
submerging a work piece to be plated in a volume of plating solution;
positioning a work piece to be plated at least partially within an upper plating channel and a lower plating channel, the upper and lower plating channels comprising non electrically conductive sides, the channels being positioned opposite each other and being separated from each other, the separation between the channels forming a pair of solution egress slots positioned approximately over the center of the work piece to be plated;
causing electrical current to flow between the work piece and one or more anodes, the current flowing into the upper and lower channels only after passing through the solution egress slots; and
moving the work piece to be plated along the length of the plating channels to form one or more internal heat spreaders on a surface of the work piece which is essentially parallel to the shields.

17. The method of 16, further comprising:
coupling the work piece to the clip device of claim 1 to hold and move the work piece during plating;
after plating, performing a first rinse and dry cycle wherein at least a portion of the frame is rinsed and dried while the work piece is kept damp;
after the first rinse and dry cycle, performing a second rinse and dry cycle wherein the work piece is rinsed and dried.

18. The method of claim 17, wherein water is used in the first and second rinse cycles, and the second rinse cycle utilizes water having fewer impurities than that used in the first rinse cycle.
